(19) United States
(12) Patent Application Publication
(10) Pub. No.: US 2017/0127440 A1
(43) Pub. Date: May 4, 2017

(54) METHOD AND DEVICE FOR RECEIVING FRAME

(71) Applicant: LG ELECTRONICS INC., Seoul (KR)

(72) Inventors: Jinyoung CHUN, Seoul (KR); Kiseon RYU, Seoul (KR); Wookbong LEE, Seoul (KR); Jinsoo CHOI, Seoul (KR); Dongguk LIM, Seoul (KR); Hangyu CHO, Seoul (KR); Suhwook KIM, Seoul (KR)

(73) Assignee: LG ELECTRONICS INC., Seoul (KR)

(21) Appl. No.: 15/317,662

(22) PCT Filed: Apr. 27, 2015
(86) PCT No.: PCT/KR2015/004180

§ 371 Date: Dec. 9, 2016

Related U.S. Application Data
(60) Provisional application No. 62/009,867, filed on Jun. 9, 2014.
(60) Provisional application No. 62/012,984, filed on Jun. 17, 2014.
(60) Provisional application No. 62/012,986, filed on Jun. 17, 2014.

(51) Int. Cl. H04W 72/12; H04W 56/00; H04W 72/04; H04L 5/00

(52) U.S. Cl. CPC H04W 72/1284; H04L 5/0055; H04L 5/0023; H04W 56/005; H04W 72/0453; H04W 72/0473; H04W 84/12

(57) ABSTRACT

Disclosed are a method and a device for receiving a frame. A method for receiving a frame in a wireless LAN comprises the steps of: an AP transmitting an uplink transmission scheduling frame to a plurality of STAs; the AP receiving, as a response to the uplink transmission scheduling frame, a sync PPDU from each STA; the AP transmitting to the plurality of STAs an adjustment frame comprising adjustment information determined on the basis of the sync PPDU; the AP receiving, on overlapped time resources, an uplink frame transmitted on the basis of the adjustment information by means of each STA; and the AP transmitting to each STA an ACK frame with respect to the uplink frame.

### BACKGROUND OF THE INVENTION

Field of the Invention

The present invention relates to wireless communications, and more particularly, relates to a method and apparatus for receiving a frame.

Related Art

In a wireless local area network (WLAN) system, distributed coordination function (DCF) may be employed as a method enabling a plurality of stations (STAs) to share a wireless medium. DCF is based on a carrier sensing multiple access with collision avoidance (CSMA/CA).

Generally, in operations under a DCF access environment, when a medium is not occupied (that is, idle) for a DCF interframe space (DIFS) interval or longer, an STA may transmit a medium access control (MAC) protocol data unit (MPDU) to be urgently transmitted. When the medium is determined to be occupied according to a carrier sensing mechanism, an STA may determine the size of a contention window (CW) using a random backoff algorithm and perform a backoff procedure. The STA may select a random value in the CW to perform the backoff procedure and determine backoff time based on the selected random value.

When a plurality of STAs attempts to access a medium, an STA having the shortest backoff time among the STAs is allowed to access the medium and the other STAs may suspend the remaining backoff times and wait until the STA having accessed the medium finishes transmission. When the STA having accessed the medium finishes frame transmission, the other STAs contend again with the remaining backoff times to acquire a transmission resource. As such, in the existing WLAN system, one STA occupies the entire transmission resource through one channel to transmit/receive a frame to/from an AP.

### SUMMARY OF THE INVENTION

An object of the present invention is to provide a method for receiving a frame.

Another object of the present invention is to provide an apparatus for receiving a frame.

In an aspect, a method for receiving a frame in a wireless LAN may include transmitting, by an access point (AP), an uplink transmission scheduling frame to multiple stations (STAs), receiving, by the AP, a sync physical layer protocol data unit (PPDU) in response to the uplink transmission scheduling frame from each of the STAs, transmitting, by the AP, an adjustment frame including adjustment information which is determined based on the sync PPDU to the multiple STAs, receiving, by the AP, an uplink frame transmitted based on the adjustment information by each of the STAs on an overlapped time resource, and transmitting, by the AP, an acknowledgement (ACK) frame in response to the uplink frame to each of the STAs, where the uplink transmission scheduling frame may include uplink (UL) multi-user (MU) transmission STA information and UL MU transmission resource information, where the UL MU transmission STA information may include information indicating the multiple STAs, where the UL MU transmission resource information may indicate a transmission resource of the uplink frame, and where the adjustment information may include information that adjusts a resource for transmitting the uplink frame.

In another aspect, an access point (AP) for receiving a frame in a wireless LAN includes a radio frequency (RF) unit configured to transmit or receive a radio signal, and a processor operatively connected to the RF unit, where the processor is configured to perform: transmitting an uplink transmission scheduling frame to multiple stations (STAs), receiving a sync physical layer protocol data unit (PPDU) in response to the uplink transmission scheduling frame from each of the STAs, transmitting an adjustment frame including adjustment information which is determined based on the sync PPDU to the multiple STAs, receiving an uplink frame transmitted based on the adjustment information by each of the STAs on an overlapped time resource, and transmitting an acknowledgement (ACK) frame in response to the uplink frame to each of the STAs, where the uplink transmission scheduling frame may include uplink (UL) multi-user (MU) transmission STA information and UL MU transmission resource information, where the UL MU transmission STA information may include information indicating the multiple STAs, where the UL MU transmission resource information may indicate a transmission resource of the uplink frame, and where the adjustment information may include information that adjusts a resource for transmitting the uplink frame.

According to the present invention, the communication efficiency may be increased by receiving a plurality of frames on an overlapped time resource from a plurality of STAs.

### BRIEF DESCRIPTION OF THE DRAWINGS

FIG. 1 is a concept view illustrating the structure of a wireless local area network (WLAN).

FIG. 2 is a conceptual view illustrating an interval between frames.

FIG. 3 is a conceptual view illustrating a UL MU transmission method according to an embodiment of the present invention.

FIG. 4 is a conceptual view illustrating a UL MU transmission method according to an embodiment of the present invention.

FIG. 5 is a conceptual view illustrating a UL MU transmission method according to an embodiment of the present invention.

FIG. 6 is a conceptual view illustrating a UL MU transmission method according to an embodiment of the present invention.

FIG. 7 is a conceptual view illustrating a UL MU transmission method according to an embodiment of the present invention.

FIG. 8 is a conceptual view illustrating a UL MU transmission preset procedure according to an embodiment of the present invention.

FIG. 9 is a conceptual view illustrating a UL MU transmission preset procedure according to an embodiment of the present invention.

FIG. 10 is a conceptual view illustrating a UL MU transmission preset procedure according to an embodiment of the present invention.

FIG. 11 is a conceptual view illustrating a PPD format for transmitting a frame according to an embodiment of the present invention.

FIG. 12 is a conceptual view illustrating a sync PPDU and an NDP according to an embodiment of the present invention.

FIG. 13 is a block diagram illustrating the wireless apparatus in which an embodiment of the present invention can be implemented.

### DESCRIPTION OF EXEMPLARY EMBODIMENTS

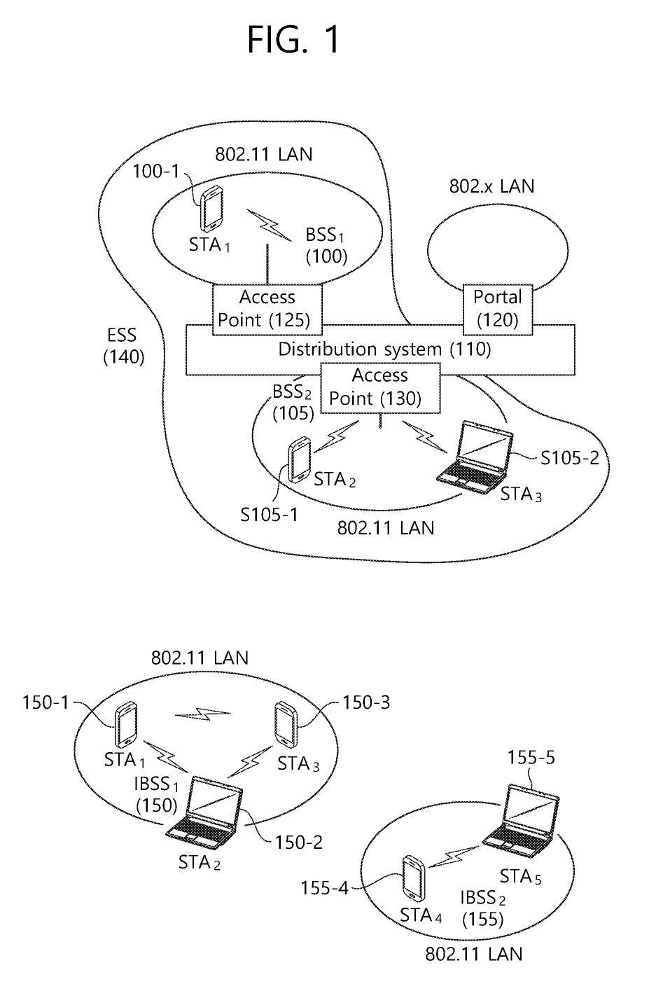

FIG. 1 is a concept view illustrating the structure of a wireless local area network (WLAN).

An upper portion of FIG. 1 shows the structure of the IEEE (institute of electrical and electronic engineers) 802.11 infrastructure network.

Referring to the upper portion of FIG. 1, the WLAN system may include one or more basic service sets (BSSs, 100 and 105). The BSS 100 or 105 is a set of an AP such as AP (access point) 125 and an STA such as STA1 (station) 100-1 that may successfully sync with each other to communicate with each other and is not the concept to indicate a particular area. The BSS 105 may include one AP 130 and one or more STAs 105-1 and 105-2 connectable to the AP 130.

The infrastructure BSS may include at least one STA, APs 125 and 130 providing a distribution service, and a distribution system (DS) 110 connecting multiple APs.

The distribution system 110 may implement an extended service set (ESS) 140 by connecting a number of BSSs 100 and 105. The ESS 140 may be used as a term to denote one network configured of one or more APs 125 and 230 connected via the distribution system 110. The APs included in one ESS 140 may have the same SSID (service set identification).

The portal 120 may function as a bridge that performs connection of the WLAN network (IEEE 802.11) with other network (for example, 802.X).

In the infrastructure network as shown in the upper portion of FIG. 1, a network between the APs 125 and 130 and a network between the APs 125 and 130 and the STAs 100-1, 105-1, and 105-2 may be implemented. However, without the APs 125 and 130, a network may be established between the STAs to perform communication. The network that is established between the STAs without the APs 125 and 130 to perform communication is defined as an ad-hoc network or an independent BSS (basic service set).

A lower portion of FIG. 1 is a concept view illustrating an independent BSS.

Referring to the lower portion of FIG. 1, the independent BSS (IBSS) is a BSS operating in ad-hoc mode. The IBSS does not include an AP, so that it lacks a centralized management entity. In other words, in the IBSS, the STAs 150-1, 150-2, 150-3, 155-1, and 155-2 are managed in a distributed manner. In the IBSS, all of the STAs 150-1, 150-2, 150-3, 155-1, and 155-2 may be mobile STAs, and access to the distribution system is not allowed so that the IBSS forms a self-contained network.

The STA is some functional medium that includes a medium access control (MAC) following the IEEE (Institute of Electrical and Electronics Engineers) 802.11 standards and that includes a physical layer interface for radio media, and the term “STA” may, in its definition, include both an AP and a non-AP STA (station).

The STA may be referred to by various terms such as mobile terminal, wireless device, wireless transmit/receive unit (WTRU), user equipment (UE), mobile station (MS), mobile subscriber unit, or simply referred to as a user.

The access point (AP) operated in the wireless local area network (WLAN) system may transmit data to each of a plurality of stations (STAs) through the same time resource. When the transmission from an AP to an STA is referred to as a downlink transmission, such a transmission of an AP may be expressed by the term, a downlink multi-user (DL MU) transmission.

In the conventional WLAN system, an AP was able to perform the DL MU transmission based on the multiple input multiple output (MU MIMO), and such a transmission may be expressed by the term, a DL MU MIMO transmission. In the embodiments of the present invention, an AP may perform the DL MU transmission based on the orthogonal frequency division multiplexing access (OFDMA), and such a transmission may be expressed by the term, a DL MU OFDMA transmission. In the case that the DL MU OFDMA transmission is used, an AP may transmit a DL frame to each of STAs through each of a plurality of frequency resources on an overlapped time resource.

The PPDU, the frame and the data transmitted through the downlink transmission may be expressed by a DL PPDU, a DL frame and a DL data, respectively. The PPDU may be a unit of data that includes a PPDU header and a physical layer service data unit (PDSU) (or an MAC protocol data unit (MPDU)). The PPDU header may include a PHY header and a PHY preamble, and the PDSU (or MPDU) may include a frame or indicate a frame.

On the other hand, the transmission from an STA to an AP is referred to as an uplink transmission, the transmission transmitted by a plurality of STAs to an AP on the same time resource may be expressed by an uplink multi-user (UL MU) transmission. Different from the conventional WLAN system, in the WLAN system according to the embodiments of the present invention, the UL MU transmission may be supported. The PPDU, the frame and the data transmitted through the UL transmission may be expressed by a UL PPDU, a UL frame and a UL data, respectively. The uplink transmission performed by each of a plurality STAs may be performed on a frequency domain or a spatial domain.

In the case that the UL transmission by each of the STAs is performed on a frequency domain, different frequency resources for a plurality of STAs may be allocated as the UL transmission resource based on the orthogonal frequency division multiplexing access (OFDMA). Each of the STAs may transmit a UL frame to an AP through different frequency resources allocated. Such a transmission method through different frequency resources may be expressed by a UL MU OFDMA transmission method.

In the case that the UL transmission by each of the STAs is performed on a spatial domain, different space time streams (or spatial streams) are allocated to a plurality of STAs, respectively, and each of the STAs may transmit a UL frame to an AP through different space time streams. Such a transmission method through different space time streams may be expressed by a UL MU MIMO transmission method.

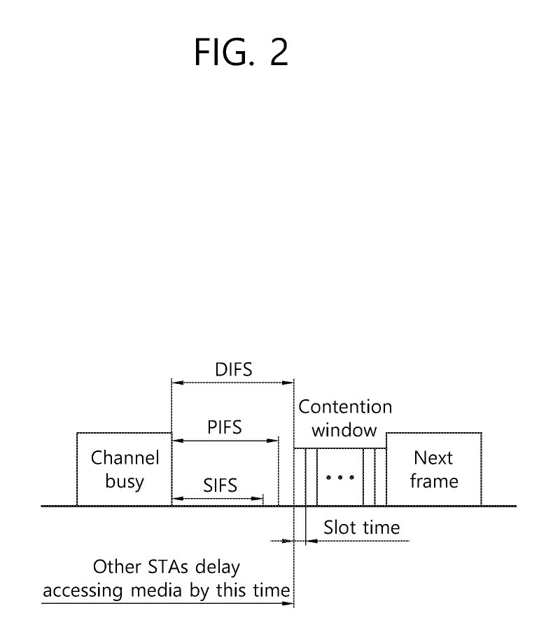

FIG. 2 is a conceptual view illustrating an interval between frames.

Referring to FIG. 2, the time interval between two frames transmitted on a medium may be referred to as an interframe space (IFS). Based on the IFS of different lengths, the priority of STA that occupies a radio medium may be determined. The frame transmitted on a medium may be transmitted based on the IFS of different lengths. For example, different IFSs may be used for transmitting a frame on a medium.

(1) SIFS (short inter frame symbol): used for transmitting an RTS (request to send) frame/a CTS (clear to send) frame and an ACK (acknowledgement) frame.

(2) PIFS (PCF (point coordination function) IFS): used for transmitting a PCF frame (e.g., a channel switch announcement frame, TIM (traffic indication map), etc.) and transmitting the STA that performs a channel access based on the PCF (point coordination function).

(3) DIFS (DCF IFS): used for transmitting a frame of an STA that performs the channel access based on a DCF.

(4) EIFS (extended IFS): used only when a frame transmission error occurs, which is not fixed interval

The formula of each IFS is as shown in Equation 1 to Equation 3 below, and the numeral in the parenthesis as a side of each parameter may be a normal numerical value for each parameter. The value of each parameter may be changed depending on the capability or communication environment of an STA. Each Equation is posted in section 9.3.7 DCF timing relation of IEEE P802.11-REVmcTM/D2.0 document disclosed on October 2013, and the parameter used in each Equation is posted in section 6.5.4 PLME-CHARACTERISTICS.confirm of IEEE P802.11-REVmcTM/D2.0 document, section 6.5 PLME SAP interface of IEEE Std 802.11ac™-2013 document, and so on.

SIFS(16 μs)=aRxRFDelay(0.5)+aRxPLCPDelay(12.5)+aMACProcessingDelay(1 or <2)+aRxTxTurnaroundTime(<2)

aRxTxTurnaroundTime=aTxPLCPDelay(1)+aRxTxSwitchTime(0.25)+aTxRampOn Time(0.25)+aTxRFDelay(0.5) <Equation 1>

Referring to Equation 1, the SIFS may be the value considering a delay in radio frequency (RF) terminal, a delay in physical layer convergence protocol (PLCP) terminal, a medium access control (MAC) processing delay and a time transition from Rx to Tx. For example, the SIFS may be from the time of receiving the last symbol of a reception frame of an STA from a medium (or an air interface) to the time of the first symbol of a transmission frame of an STA being transmitted to a medium (or an air interface).

PIFS(25 μs)=aSIFSTime+aSlotTime

aSlotTime=aCCATime(<4)+aRxTxTurnaroundTime(<2)+aAirPropagationTime(<1)+aMACProcessingDelay(<2) <Equation 2>

Herein, the aAirProgationTime may be two times of the propagation time (or the propagation delay) for a signal transmission in the maximum distance between STAs slot-synchronized located in the farthest distance in a communication range. Herein, the aAirProgationTime may be a value of 1 μs or less. The radio wave may be propagated in the speed of 300 m/μs.

DIFS(distributed(coordination function)interframe space)(34 μs)=aSIFSTime+2×aSlotTime <Equation 3>

Referring to Equation 1 to Equation 3, the values of SIFS, PIFS and DIFS may be changed depending on the capability of an STA and/or the wireless communication environment. For example, the SIFS may have a value of maximum 16 μs and the PIFS may have a value of minimum 16 μs to maximum 25 μs depending on the capability of an STA and/or the wireless communication environment.

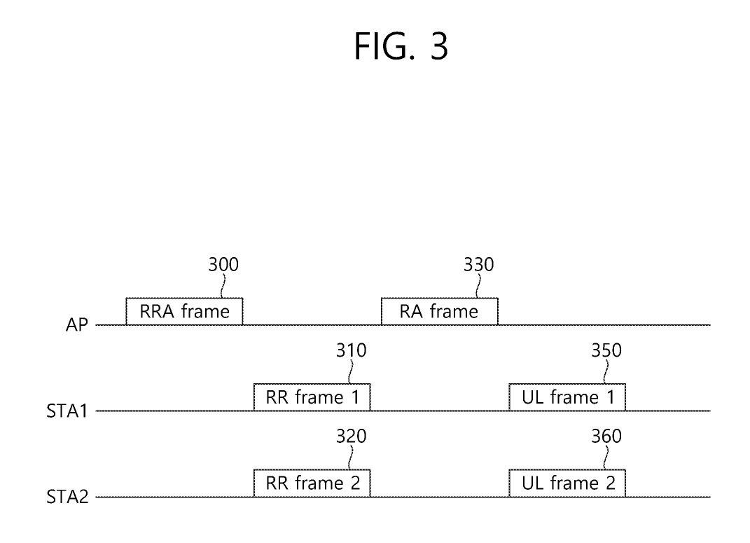

FIG. 3 is a conceptual view illustrating a UL MU transmission method according to an embodiment of the present invention.

For the UL MU transmission of a plurality of STAs to perform in the WLAN system, an AP should transmit the information of the resource (e.g., space time stream or frequency resource) for transmitting UL frames to a plurality of STAs.

The AP may schedule the UL MU transmission of a plurality of STAs based on the information on whether a pending UL data is existed in the STA that is included in (or associated with) a BSS and the information of the channel situation between the STA included in (or associated with) a BSS and the AP.

FIG. 3 shows the method for allocating the UL transmission resource to each of STAs of the AP and receiving the UL frame from each of the STAs.

The AP may transmit a resource request announcement (RRA) frame 300 to a plurality of STAs. The RRA frame 300 may be used for triggering or announcing the request of the UL transmission resource to each of the STAs. The RRA frame 300 may be transmitted based on the broadcast, the multicast or the unicast. The detailed method for transmitting the RRA frame 300 will be described below.

Each of the STAs may transmit resource request frames 310 and 320 to the AP in response to the RRA frame 300. The RR frames 310 and 320 may be used for requesting the UL transmission resource to the AP. The RR frames 310 and 320 may be transmitted by each of the STAs. based on at least one multiplexing scheme of the code division multiplexing (CD), the frequency division multiplexing (FDM), the time division multiplexing (TDM) and the space division multiplexing (SDM) on the transmission duration of the RR frames 310 and 320. The transmission method of the RR frame 310 and 320 will be described in detail below.

The AP that receives the RR frame 310 and 320 may transmit the resource assignment (RA) frame 330 to a plurality of STAs. The RA frame 330 may be a frame for allocating (or scheduling) the UL transmission resource to each of the STAs.

Each of the STAs that receive the RA frame 330 may transmit the UL frame (for example, UL data frame, UL management frame 350, 360) through the UL transmission resource.

In the case that the information of the transmission timing of the RR frames 310 and 320 is included in the RRA frame 300, the RR frames 310 and 320 may be transmitted based on the transmission timing information included in the RRA fame 300. In addition, in the case that the information of the transmission timing of the UL frame 350 and 360 is included in the RA frame 330, the UL frame 350 and 360 may be transmitted based on the transmission timing information included in the RA fame 330.

In the case that the information on the transmission timing of the frame as above may not be saved, the interval between frames may be one of SIFS, DIFS, or PIFS that is predefined. As described above, SIFS, DIFS, or PIFS is a value changeable according to the capability of a STA or channel circumstances. Or the interval of frames may be a fixed-size value (FIFS, fixed interframe space) that is newly defined for transmission of the UL MU. In the case that the fixed-size interframe space is used, unlike the existing SIFS, DIFS, or PIFS, the AP may receive multiple UL frames within a regular error range. The interval between frames may be different each other. For example, the interval between the RRA frame 300 and the RR frame 310 is SIFS, and the interval between the RA frame 330 and the UL frames 350, 360 may be a fixed size.

According to the embodiment of the present invention, the transmission timing of the RA frame 330 after the transmission of the RR frames 310 and 320 is not separately defined, the AP may performed a contention-based channel access with different STAs for the transmission of the RA frame 330.

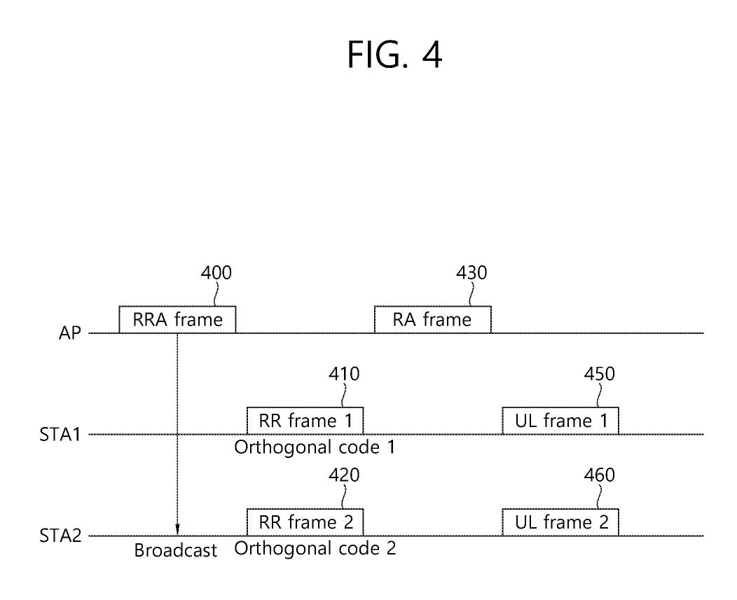

FIG. 4 is a conceptual view illustrating a UL MU transmission method according to an embodiment of the present invention.

FIG. 4 shows the UL MU transmission procedure of the RRA frame, which is transmitted in a broadcast manner.

Referring to FIG. 4, the AP may transmit the RRA frame 400 in a broadcast manner. The RRA frame 400 may be a frame that is newly defined in order to trigger (or inform) resource requests. Otherwise, the RRA frame 400 may be a beacon frame including an additional control field. That is, a control field for triggering resource requests may be included in the beacon frame, and the beacon frame including such a control field may be used as the RRA frame 400. Hereinafter, it is assumed the number of STAs that transmit the RR frame and the UL frame is plural, but one STA may transmit the RR frame and the UL frame, which embodiment is included in the scope of the present invention.

Each of the STAs may transmit the RR frames 410 and 420 to an AP after receiving the RRA frame 400. The IFS between the RR frames 410 and 420, and the RRA frame 400 may be SIFS, DIFS, PIFS, FIFS and so on.

The RR frames 410 and 420 may be transmitted by each of the STAs based on one of the multiplexing method such as CDM, FDM, TDM or SDM.

In the case of the transmission of the CDM-based RR frames 410 and 420, an STA (STA 1) may transmit the RR frame 410 to an AP based on the orthogonal code 1 among multiple orthogonal codes. Another STA (STA 2) may transmit the RR frame 2 420 to an AP based on the orthogonal code 2 among multiple orthogonal codes. In such a case, on the overlapped time resource, each of the STAs may transmit the RR frames 410 and 420 to an AP. In the case that the number of subcarrier that is used for the transmission of the RR frames 410 and 420 is n, there may be existed n orthogonal codes of the length n. The multiple STAs may transmit the RR frames 410 and 420 using one of n orthogonal codes respectively.

In the case of the transmission of the FDM-based RR frames 410 and 420, a STA may transmit the RR frames 410 and 420 based on one subband among multiple subbands (frequency resources). The entire transmission band may include multiple subbands, each of the STAs may transmit the RR frames 410 and 420 through different subbands on the overlapped time resource.

In the case of the transmission of the TDM-based RR frames 410 and 420, each of the STAs may transmit the RR frames 410 and 420 through the overlapped frequency resources on different time resources.

In the case of the transmission of the SDM-based RR frames 410 and 420, each of the STAs may transmit the RR frames 410 and 420 through different space time streams (or spatial streams) that are generated based on free coding matrix (or vector) on the overlapped time resource.

The RR frames 410 and 420 may be transmitted based on 2 multiplexing methods at least among the CDM, the FDM, the TDM, and the SDM.

For example, the FDM and the CDM may be used for transmitting the RR frames 410 and 420. For example, n subcarriers are divided by a subband (or a group) including f subcarriers and applying n/f length orthogonal code per a subband, so that each of the STAs may transmit the RR frames 410 and 420 on the overlapped time resource based on the FDM and the CDM.

A specific information may correspond to an orthogonal code, frequency resource, time resource, and time space stream resource that are selected for the transmission of the RR frame 410 and 420. That is, the orthogonal code, the frequency resource, the time resource, and the time space stream resource that are selected for the transmission of the RR frame 410 and 420 may implicitly transmit the specific information.

For a concrete example, it is assumed that n orthogonal codes are group by q orthogonal codes and the orthogonal code groups are used for the transmission of the RR frame by each of the STAs. In this case, n/q STAs may transmit the RR frame 410 and 420 based on different orthogonal codes. And also, each of q orthogonal codes included in the orthogonal code groups may correspond to (or match with) the respective information that corresponds to log₂q bit. For a particular example, in the case that four orthogonal codes (orthogonal code 1 to 4) are included in an orthogonal code group, each of orthogonal code 1, orthogonal code 2, orthogonal code 3, and orthogonal code 4 may match with the information corresponding to 00, 01, 10 and 11 respectively. That is, depending on which orthogonal code are selected by an STA among q orthogonal codes included in the orthogonal code group for the transmission of the RR frames 410 and 420, the information corresponding to log₂q bit may be implicitly transmitted.

For another example, it is assumed that n subbands are group by q subbands and the subband groups are used for the transmission of the RR frame by each of the STAs. In this case, n/q STAs may transmit the RR frame 410 and 420 based on different subbands. And also, each of q subbands included in the subband groups may correspond to (or match with) the respective information that corresponds to log₂q bit. That is, depending on which subband are selected by an STA among q subbands included in the subband group for the transmission of the RR frames 410 and 420, the information corresponding to log₂q bit may be implicitly transmitted.

The information that is implicitly transmitted based on the orthogonal code, the frequency resource, the time resource, or the time space stream resource for the transmission of the RR frames 410 and 420 may be the information for scheduling the UL MU transmission of an AP (for example, select an STA that is going to perform the UL MU transmission). For example, the information that is implicitly transmitted based on the orthogonal code, the frequency resource, the time resource, or the time space stream resource for the transmission of the RR frames 410 and 420 may be the information of access category (AC), buffer status, backoff count, preferred bandwidth, and so on.

According to another embodiment of the present invention, only a part of multiple symbols (OFDM symbols) of the RR PPDU carrying (or containing) the RR frames 410 and 420 may be used for the resource request of STA. For example, a part of OFDM symbols among multiple OFDM symbols for the RR PPDU transmission may be used according to access category (AC) of the UL data (or UL data frame) pending on an STA. The rest symbols that are not used may be included in null data.

According to another embodiment of the present invention, according to access category (AC) of the UL data (or UL data frame) pending on an STA, the STA may determine whether to transmit the RR frame. The RRA frame 400 may trigger the transmission of the RR frames 410 and 420 only for the STA that owns a pending UL data corresponding to a specific AC (for example, voice (VO)). The RRA frame 400 may include the information for triggering the transmission of the RR frames 410 and 420 only for the STA that owns a pending UL data corresponding to the AC_VO.

That is, for each AC of the UL data, the transmission and reception duration of the RRA frame 400 and the RA frame 430 may be separately configured.

In the case that the RR frames 410 and 420 do not include the identification information (MAC address, identifier etc.) of an STA, the AP may not know the identification information of the STA that transmits the RR frames 410 and 420. The RR frames 410 and 420 may be transmitted by the STA based on a specific orthogonal code, specific time resource, specific frequency resource, and specific time space stream (hereinafter, referred to as a specific transmission resource). In addition, the specific transmission resource may include additional information (AC, buffer status, backoff count, preferred bandwidth etc.) as described above.

The AP may transmit the RA frame 430 to the STA by using additional information that is transmitted based on specific transmission resources. For example, in the case that the STA transmits the RR frame 1 410 generated based on an orthogonal code 1, the AP may transmit the RA frame 430 generated based on the orthogonal code 1 in response to the RR frame 1 410. The RA frame 430 may include the information of the transmission resource for the transmission of the UL frames 450 and 460 for each of the STAs. Each of the STAs may transmit the UL frames 450 and 460 through the transmission resource assigned based on the RA frame 430.

Or, the AP may transmit additional information request frame (or signal) that instructs to transmit additional information in order to transmit the RA frame 430 to the STA, which transmit the RR frames 410 and 420 based on the specific transmission resource before the transmission of the RA frame 430. The AP may transmit the RA frame 430 to the STA after receiving additional information request frame. The additional information request frame may include the information that requests identification information of the STA that transmits the RR frames 410 and 420 based on the specific transmission resource.

According to another embodiment of the present invention, the RR frames 410 and 420 may be distinguished as specific transmission resource duration and information duration. For example, the specific transmission resource duration is a duration in which transmission may be performed using a specific code based on the CDM and the information duration may be a duration in which specific transmission resource is not used.

For example, the first OFDM symbol of the RR PPDU that delivers the RR frames 410 and 420 is transmitted based on n subcarriers, and additional orthogonal code may be applied to the n subcarriers. The second OFDM symbol of the RR PPDU may transmit a symbol generated based on the modulation method of binary phase shift keying (BPSK) and the code rate 1/2.

The second OFDM symbol of the RR PPDU may be decoded by performing channel estimation based on the information that is transmitted on the first OFDM symbol.

In the case that there is great number of STAs that transmit the RR frames 410 and 420 without the orthogonal code being applied to the second symbol, The second OFDM symbol is more likely to break due to the conflict between frames. Therefore, in order to decrease the error rate for the second OFDM symbol, the CRC may be included in the RR PPDU. In the case that it is impossible to decode the information that is transmitted on the second OFDM symbol, the CRC-based error detection may be performed. In the case that it is available to decode the information that is transmitted on the second OFDM symbol, the AP may be scheduling the UL MU transmission of multiple STAs based on the information transmitted on the second OFDM.

The information that is transmitted on the second OFDM symbol may include the information for scheduling the UL MU transmission of multiple STAs of the AP such as association identifier (AID), request data size (pending UL data size), modulation and coding scheme (MCS) of the STA, and so on.

The time synchronization between multiple STAs that transmit the RR frames 410 and 420 may not be set. According to an embodiment of the present invention, the duration (or length) of the OFDM symbol that transmits the RR frames 410 and 420 may be set to be two times or four times of other frames. In such a case, the length of GI (or CP) on the OFDM symbol may be extended, and the error between reception timings may be the GI duration. Therefore, the AP may perform decoding for the RR frames 410 and 420 that are transmitted by each of STAs. Or the length of GI only may be extended while the length of valid symbol duration among the OFDM symbol durations may be maintained.

The AP receiving the RR frames 410 and 420 may correct the error of the reception timing of the UL frames 450 and 460 that are transmitted by each of the STAs. That is, the AP may determine the reception timing error of multiple STAs that are going to transmit the UL frames 450 and 460 determined based on the RR frames 410 and 420. The AP may determine the respective time-advanced value (or transmission timing offset) of multiple STAs based on the reception timing error of multiple STAs and transmit it to multiple STAs. The respective time-advanced value (or transmission timing offset) of multiple STAs may be included in the RA frame 430.

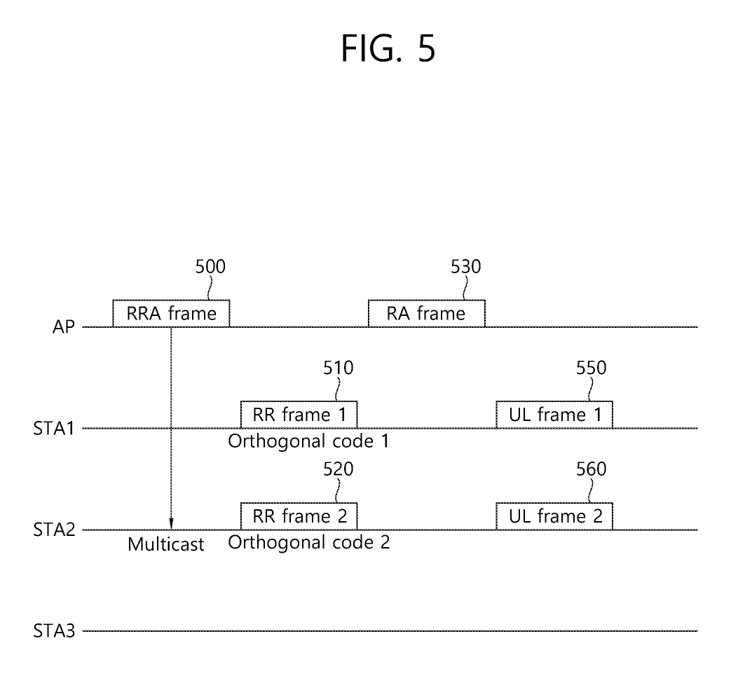

FIG. 5 is a conceptual view illustrating a UL MU transmission method according to an embodiment of the present invention.

FIG. 5 describes the UL MU transmission procedure using the RRA frame that is transmitted in a multicast manner.

Referring to FIG. 5, the AP may transmit the RRA frame 500 in the multicast manner. The RRA frame 500 that is transmitted in a multicast manner may be received by multiple STAs. The RRA frame 500 that is transmitted in a multicast manner may include the information indicating the multiple STAs that are going to receive the RRA frame 500 (MAC address of STA, AID of STA, etc.)

As described above, the RR frames 510 and 520 may be transmitted by each of the STAs based on one multiplexing method at least among the CDM, the FDM, the TDM or the SDM.

The RR frame 500 may include the information indicating the transmission resource for the transmission of the RR frames 510 and 520 by each of the STAs that receive the multicast RRA frame 500. The information indicating the transmission resource may indicate at least one of the orthogonal code, the time resource, the frequency resource and the time space stream that are for the transmission of the RR frames 510 and 520.

Each of the STAs indicated based on the RRA frame 500 may transmit the RR frames 510 and 520 through the transmission resource indicated based on the RRA frame 500. The AP may receive the RR frames 510 and 520 from each of STAs, and include the identification information of each of the STAs that transmit the RR frames 510 and 520 based on the transmission resource of the RR frames 510 and 520. The RR frames 510 and 520 may include the identification information of the STA indicating the STA that transmits the RR frames 510 and 520.

The AP may determine the resource allocation information for transmitting the UL frames 550 and 560 of each of the STAs based on the multiple RR frames 510 and 520 that are received by multiple STAs. The AP may transmit the RA frame 530 including the determined resource allocation information to multiple STAs.

Each of the STAs that receive the RA frame 530 may transmit the UL frames 550 and 560 to the AP through the transmission resource allocated based on the RA frame 530.

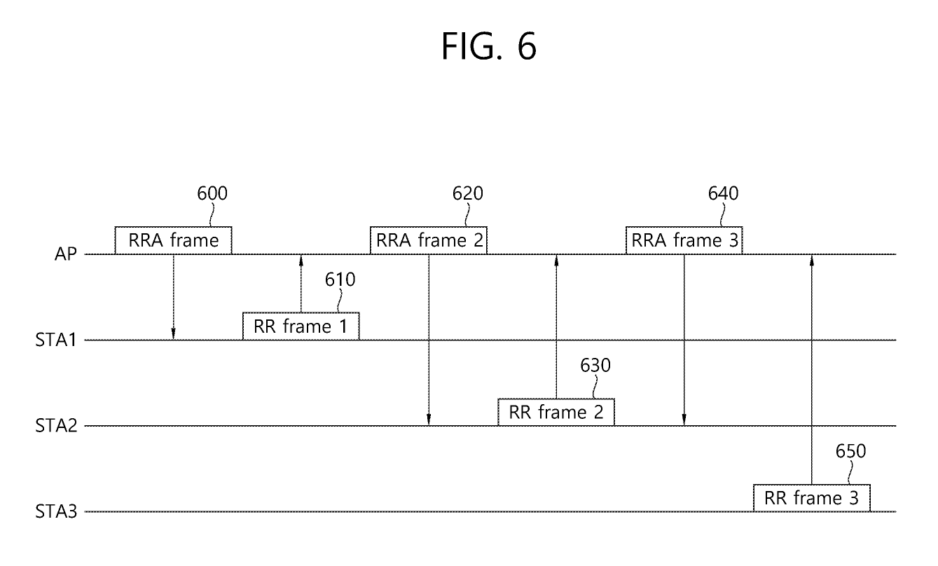

FIG. 6 is a conceptual view illustrating a UL MU transmission method according to an embodiment of the present invention.

FIG. 6 shows a transmission procedure of the UL frame of a plurality of STAs based on the RRA frame transmitted in the unicast manner.

An AP may transmit the RRA frame to each of the STAs using the unicast manner. For example, the AP may trigger a transmission of an RR frame 1 610 by STA1 and may receive the RR frame 1 610 from STA1 by designating STA1 based on RRA frame 1 600.

The AP may trigger a transmission of an RR frame 2 620 by STA2 and may receive the RR frame 2 620 from STA2 by designating STA2 based on RRA frame 2 620.

The AP may trigger a transmission of an RR frame 3 650 by STA3 and may receive the RR frame 3 650 from STA3 by designating STA3 based on RRA frame 3 640.

In the case that the RRA frame is transmitted and the RR frame is received in the unicast manner, the RR frame is not required to be transmitted based on different orthogonal codes, frequency resources and space time streams.

According to an embodiment of the present invention, the RRA frame and the RR frame are not newly defined but the DL frame and the UL frame defined on the existing WLAN may be used for the procedure based on the RRA frame and the RR frame. The DL frame and the UL frame defined on the existing WLAN may include the information for performing the procedure based on the RRA frame and the RR frame (e.g., the information for triggering the resource request and the information for the resource request) described above. This may also be applied to FIG. 4 and FIG. 5 described above, and the RRA frame and the RR frame are not newly defined but the DL frame and the UL frame defined on the existing WLAN may be used.

According to an embodiment of the present invention, the transmission of the RRA frame and the RR frame may be periodically performed. For example, in the case that the beacon frame that includes the information for the resource request additionally is used for the RRA frame, each of the STAs may transmit the RR frame to the AP according to the transmission period of the beacon frame and may be allocated with the transmission resource for the UL transmission from the AP.

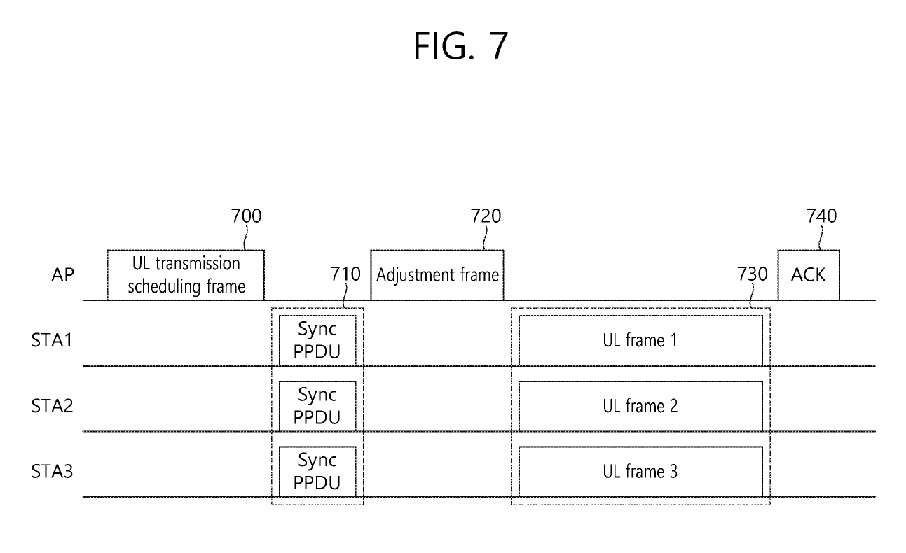

FIG. 7 is a conceptual view illustrating a UL MU transmission method according to an embodiment of the present invention.

FIG. 7 shows a method for performing an adjustment procedure for a UL MU transmission of multiple STAs.

After an AP schedules the UL MU transmission of the multiple STAs based on a UL transmission scheduling frame (or UL MU scheduling frame) 700 and performs the adjustment procedure for the UL MU transmission, and the AP may receive a UL frame from the multiple STAs.

In the adjustment procedure between the AP and the multiple STAs, each of the STAs may transmit a sync frame (or sync PPDU) 710 that includes a sync signal. The AP may transmit the UL transmission scheduling frame to the multiple STAs, and may receive the sync PPDU in response to the UL transmission scheduling frame from each of the STAs. The sync PPDU 710 may be used for generating the adjustment information (e.g., at least one of the time adjustment information, the frequency adjustment information and the power adjustment information) by the AP.

The time adjustment information may be the information for adjusting the transmission timing of a UL frame 730 of each of the STAs. The frequency adjustment information may be the information for adjusting the transmission frequency band of the UL frame 730 of each of the STAs. The power adjustment information may be the information for adjusting the transmission power of the UL frame 730 of each of the STAs.

The adjustment information may be transmitted with being included in an adjustment frame 720 which is transmitted by the AP. In the case that the multiple STAs that receive the adjustment information through the adjustment frame 720 requires an adjustment, the multiple STAs may perform the adjustment of at least one of the time resource for transmitting the UL frame 730, the frequency resource and the power for transmitting the UL frame based on the adjustment information.

Such a procedure based on the sync PPDU 710 and the adjustment frame 720 may be performed after the transmission of the UL transmission scheduling frame 700. Accordingly, the STA may have the time for processing (or configuring) the UL frame 730 that is going to be transmitted to the AP after receiving the UL transmission scheduling frame 700.

Each of the STAs may transmit the UL frame 730 to the AP based on the adjustment information. The AP may receive the UL frame 730 transmitted based on the adjustment information by each of the STAs on the overlapped time resources. The adjustment information may be the information for adjusting the resource for transmitting the UL frame. The AP may transmit an ACK frame (or block ACK frame) 740 in response to the UL frame 730.

Particularly, the UL transmission scheduling frame 700 may include the UL MU transmission STA information for indicating multiple STAs that are going to perform the UL transmission based on the UL MU transmission and the UL MU transmission resource information for the transmission resource allocated to each of the STAs that are going to perform the UL transmission based on the UL MU transmission. The UL MU transmission STA information may include the identification information or the MAC address for indicating each of the STAs or the group identification information for indicating each of the STAs.

In the case that the UL MU OFDMA transmission is performed, the UL MU transmission resource information may include the information for the subband (or subcarrier, frequency resource) that is going to be used for transmitting the UL frame 730 of each of the STAs. Otherwise, in the case that the UL MU MIMO transmission is performed, the UL MU transmission resource information may include the information for the space time stream that is going to be used for transmitting the UL frame 730 of each of the STAs.

In the case that the transmission of the UL frame 730 of each of the STAs is performed based on the FDM, the CDM or the TDM, the UL MU transmission resource information may include the information for the frequency resource, the information for the orthogonal code or the information for the time resource that is going to be used for transmitting the UL frame 730 of each of the STAs.

In addition, the UL transmission scheduling frame 700 may further include the information for the MCS and the coding rate that is going to be used for transmitting the UL frame 730 of each of the STAs.

The UL transmission scheduling frame 700 may include the legacy parts (e.g., L-STF, L-LTF and L-SIG) and the non-legacy parts (e.g., HE-LTF, HE-SIG, HE-STF, etc.). The legacy STA that does not support the UL MU transmission may receive the legacy part of the UL transmission scheduling frame 700 and may perform the NAV configuration based on the information (e.g. duration information (or length information, etc.)) for configuring the network allocation vector (NAV) included in the legacy part.

The sync PPDU (or sync signal) 710 and the adjustment frame 720 may be used for the time adjustment, the frequency adjustment and the power adjustment for transmitting the UL frame 730 of each of the STAs that transmit the UL frame 730 in the UL MU transmission.

Each of the STAs may transmit the sync PPDU 710 through the transmission resource indicated based on the UL transmission scheduling frame 700. Particularly, each of the STAs may transmit the sync PPDU 710 on the frequency resource (e.g., subband) allocated to transmitting the UL frame 730, allocated space time stream, the allocated orthogonal code or the allocated time resource.

Otherwise, the transmission resource of the sync PPDU 710 transmitted by each of the STAs may be allocated based on the order of the multiple STAs indicated by the UL MU transmission STA information of the UL transmission scheduling frame 700.

Particularly, the UL MU transmission STA information of the UL transmission scheduling frame 700 may sequentially indicate STA1, STA2 and STA3. In the case that the sync PPDU 710 is transmitted based on the CDM, STA1 may transmit a first sync PPDU generated based on orthogonal code 1 (or sequence 1), STA2 may transmit a second sync PPDU generated based on orthogonal code 2 (or sequence 2), and STA3 may transmit a third sync PPDU generated based on orthogonal code 3 (or sequence 3). The sync PPDU 710 may be transmitted based on the TDM, the FDM, the UL MU OFDMA or the UL MU MIMO as well as the CDM similar to the transmission method of the UL frame, but the transmission resource of the sync PPDU 710 of each of the STAs may be determined according to the order of the multiple STAs indicated based on the UL MU transmission STA information.

The sync PPDU 710 may include the PPDU header (PHY header and PHY preamble) only that includes the legacy part and the non-legacy part, or the non-legacy part (HE-LTF, HE-SIG and HE-STF) only (i.e., the sync PPDU may not include the legacy part (L-LTF, L-SIG and L-STF) of the PPDU header and the MAC frame.).

The adjustment frame 720 may be transmitted to a single STA based on the DL SU transmission or may be transmitted to a plurality of STAs based on the DL MU transmission. For example, in the case that there is one STA that is going to be adjusted, the adjustment frame 720 may be transmitted to a single STA. In the case that there are multiple STAs that are going to be adjusted, the adjustment frame 720 may be transmitted to the multiple STAs.

The adjustment frame 720 may include the information indicating at least one STA that is going to receive the adjustment frame 720. Otherwise, assuming that all of the multiple STAs that receive the UL transmission scheduling frame 700 receive the adjustment frame 720, the adjustment frame 720 may not include the information that is going to indicate the received STA.

The adjustment frame 720 may include at least one of the time adjustment information, the frequency adjustment information and the power adjustment information. The time adjustment information may include the information for adjusting the transmission timing of the UL frame 730 of at least one STA among the multiple STAs that are going to transmit the UL frame.

The frequency adjustment information may include the information for adjusting the transmission frequency band of the UL frame 730 of at least one STA among the multiple STAs that are going to transmit the UL frame.

The power adjustment information may include the information for adjusting the transmission power of the UL frame 730 of at least one STA among the multiple STAs that are going to transmit the UL frame.

The adjustment frame 720 may include other additional information for transmitting the UL frame 730 in addition to the time adjustment information, the frequency adjustment information and the power adjustment information.

The PPDU header of the adjustment PPDU that delivers (or includes) the adjustment frame 720 may include the non-legacy part (e.g., HE-LTF, HE-SIG, HE-STF, etc.) only without the legacy part.

In FIG. 7, the case that the adjustment procedure based on the sync PPDU 710 and the adjustment frame 720 is performed after transmitting the UL transmission scheduling frame 700 is assumed and described. However, the adjustment procedure may be performed before transmitting the UL transmission scheduling frame 700. Otherwise, the UL transmission scheduling frame 700 may be transmitted to the multiple STAs with at least one of the time adjustment information, the frequency adjustment information and the power adjustment information being included. For example, the AP may generate the adjustment information based on the UL frame or the sync PPDU transmitted from each of the STAs previously, and may transmit the adjustment information through the UL transmission scheduling frame 700.

In addition, for the STAs that do not require the time adjustment, the frequency adjustment and the power adjustment, the UL frame 730 may be transmitted without the adjustment procedure. In the case that only a part of the time adjustment, the frequency adjustment and the power adjustment is required, the adjustment for the part that requires the adjustment may be performed. For example, in the case that the length of CP used in the UL frame 730 is greater than the difference of the reception timings between the multiple UL frames 730 that are transmitted based on the UL MU transmission (i.e., in the case that the synchronization of which CP (or GI) length is misaligned is adjustable), the procedure (or time adjustment information) for compensating the time difference may be omitted. Otherwise, in the case that the gourd band of the frequency resource for transmitting the UL frame 730 allocated to each of the STAs when transmitting a plurality of UL frames 730 based on the UL MU OFDMA transmission, the procedure for compensating the different (or frequency offset) between the frequency resources allocated to each of the STAs may be omitted.

According to the UL transmission scheduling frame 700, the multiple STAs may transmit the UL frame 730. The UL PPDU that delivers the UL frame 730 may not include the legacy part (L-STF, L-SIG and L-LTF). Otherwise, the UL PPDU includes the legacy part but the legacy part may be transmitted based on the single frequency network (SFN). In the case that the transmission of the legacy part based on the SFN is performed, the legacy part of the same configuration (or including the same information) may be transmitted on the overlapped time resource by the all STAs that perform the UL MU transmission.

The UL frame 730 may not include the SIG field that includes the control information for the UL frame configuration, or a part of the existing control information included in the SIG field may be used for other purpose.

In the case that the information of the UL frame 730 (e.g., the control information for the configuration scheme of the UL frame) is included in the UL transmission scheduling frame 700, the part of the control information for the UL frame 730 may not be included in the SIG of the UL frame 730.

An ACK frame (or block ACK frame) 740 may be transmitted to the multiple STAs in response to the UL frame 730. In an embodiment of the present invention, for the convenience of description, it is assumed that the ACK frame 740 is transmitted in response to the UL frame 730, but the block ACK frame may also be transmitted in response to the UL frame.

The RA field of the ACK frame 740 may include the identification information (AID or partial AID) of the multiple STAs that perform the UL MU transmission. The ACK frame 740 may include the ACK information (or signal; or NACK information (or signal) in response to each of the UL frames 730 transmitted. For example, the ACK information (or NACK information) for each of the UL frames 730 transmitted may be transmitted based on the bitmap. The ACK signal may indicate the success of the decoding for the UL frame, and the NACK signal may indicate the failure of the decoding for the UL frame. Otherwise, the ACK frame 740 may not include the ACK signal for the UL frame in which the decoding is failed.

Otherwise, the ACK frame 740 may be transmitted to the multiple STAs based on the DL MU transmission (the DL MU OFDMA transmission or the DL MU MIMO transmission). In the case that a plurality of ACK frames 740 is transmitted based on the DL MU transmission, each of the ACK frames 740 may be transmitted to the AP through the transmission resource which is the same as the transmission resource of the UL frame 730. Each of the ACK frames 740 transmitted based on the DL MU transmission may include the ACK/NACK signal for each of the UL frames 730.

Or, the ACK frame 740 may also be transmitted to the multiple STAs based on the DL SU transmission. The ACK frame 740 transmitted based on the DL SU transmission may include the ACK/NACK signals for the multiple UL frames. A specific STA may receive the ACK frame 740 transmitted based on the DL SU transmission, and may acquire the ACK/NACK signal for the UL frame that the specific STA transmits among the ACK/NACK signals for the multiple UL frames.

Otherwise, the ACK frame 740 may be transmitted to the multiple STAs that transmit the UL frame 730 using the DL SU transmission sequentially based on the information indicating each of the STAs that are going to perform the UL MU transmission included in the UL transmission scheduling frame. For example, the information indicating the multiple STAs that are going to transmit the UL frame 730 included in the UL transmission scheduling frame 700 may indicate the identification information of STA1, STA2, STA3 and STA4 sequentially. In the case that the UL frame 730 is transmitted based on the UL MU transmission by each of STA1, STA2, STA3 and STA4, the AP may sequentially transmit the ACK frame 740 based on the DL SU. That is, the ACK frame 1 for the UL frame transmitted by STA1, the ACK frame 2 for the UL frame transmitted by STA2, the ACK frame 3 for the UL frame transmitted by STA3 and the ACK frame 4 for the UL frame transmitted by STA4 may be sequentially transmitted.

The ACK frame 740 transmitted based on the DL MU or the DL SU may include the identification information for each of the STAs that transmit the UL frame 730. That is, the AP may also transmit the ACK information (or the NACK information) for each of the UL frames 730 transmitted by each of the STAs based on the identification information to each of the STAs.

The ACK PPDU that delivers the ACK frame 740 may not include the legacy part (L-STF, L-SIG, and L-LTF).

The STA that receives the NACK signal for the UL frame transmitted or fails to receive the ACK frame (or the ACK signal) for the UL frame transmitted may perform a retransmission for the UL frame.

In the case that the AP fails to receive (or decode) a specific UL frame (or in the case that the NACK signal is included in the ACK frame 740), the AP may transmit the information of the reason for the failure. In the case that the NACK signal for a specific UL frame is included in the ACK frame 740, the information of the reason for the failure of receiving (or decoding) a specific UL frame may be included in the ACK frame 740.

In addition, in the case that the NACK signal for a specific UL frame is included in the ACK frame 740, the information of the retransmission of a specific UL frame may be included in the ACK frame 740. After transmitting the ACK frame 740, the UL frame may be retransmitted through the UL MU transmission. The information for retransmitting a specific UL frame included in the ACK frame 740 may include the resource allocation information for retransmitting a specific UL frame, the information of the extension of the TXOP for retransmitting a specific UL frame, and so on. Otherwise, the information for retransmitting a specific UL frame included in the ACK frame 740 may include the time/frequency/power adjustment information for the UL MU transmission.

Hereinafter, in the embodiment of the present invention, the pre-procedure for the UL MU transmission is introduced. In the pre-procedure for the UL MU transmission, the channel state information or the buffer state information may be transmitted to the AP. The channel state information may include the communication state information for the transmission and reception of the frame between the STA and the AP. The buffer state information may include the UL data related information (e.g., data format (or contents)) that is going to be transmitted by the STA, the category of data (e.g., access category), the information of the pending UL data size (e.g., data size accumulated in queue, queue size, etc.) and the information of the transmission priority of the pending UL data (e.g., backoff count for transmitting the UL data of the STA, contention window value). Hereinafter, the pre-procedure for the UL MU transmission may be expressed by the term, UL MU transmission preset procedure.

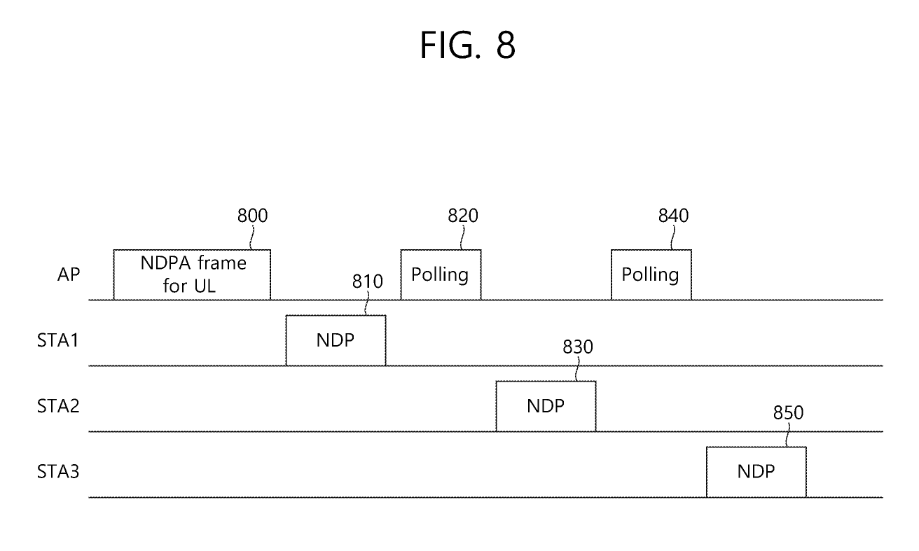

FIG. 8 is a conceptual view illustrating a UL MU transmission preset procedure according to an embodiment of the present invention.

FIG. 8 shows a method for acquiring the channel state information for each of STAs based on the sounding procedure for a plurality of STAs. The sounding procedure may be a procedure for acquiring the channel state information.

An AP may transmit a null data packet announcement (NDPA) frame 800 to an STA for the sounding procedure for a UL transmission. The NDPA frame 800 for the UL MU transmission preset procedure may include a bit for indicating the sounding procedure for the UL MU transmission.

The NDPA frame 800 may be transmitted through the entire bandwidth for a transmission of the NDPA frame 800. Such a format of PPDU may be expressed by the term, a non-duplicated PPDU format.

Otherwise, the NDPA frame 800 may be transmitted through a plurality of channels based on a duplicated PPDU format. The duplicated PPDU format may be transmitted through the bandwidth exceeding 20 MHz (e.g., 40 MHz, 80 MHz, 160 MHz, 80 MHz+80 MHz, etc.) by replicating the PPDU format which is transmitted through a neighboring channel (or primary channel; 20 MHz). In the case that the duplicated format is used, the same data may be transmitted through each of channels (replication object channel and replicated channel).

The NDPA frame 800 of the non-duplicated PPDU format and the duplicated PPDU format may be transmitted to at least one STA through at least one space stream.

The NPDA frame 800 may trigger a start of the sounding procedure to the STA and a transmission of NDPs 810, 830 and 850 by the STA. The NDPA frame 800 may include an STA information field. The STA information field may include the information of the STA that is going to transmit the NDPs 810, 830 and 850 to the AP after transmitting the NDPA frame 800.

The STA indicated based on the STA information field may transmit the NDPs 810, 830 and 850 to the AP. In the case that a plurality of STAs is indicated based on the STA information field, each of the STAs may sequentially transmit the NDPs 810, 830 and 850 to the AP.

The LTF is transmitted through at least one space time stream via the NDPs 810, 830 and 850, and the AP that sequentially receives the NDPs 810, 830 and 850 from each of the STAs may acquire the channel state information based on the LTF of the indicated space time stream and the indicated frequency domain. The NDPs 810, 830 and 850 may be a format of which a data field is omitted but only a PPDU header is included in the general PPDU.

For example, an STA among a plurality of STAs indicated based on the STA information field may transmit the NDP 810 to the AP after receiving the NDPA frame 800, and each of the remaining STAs among a plurality of STAs indicated based on the STA information field may transmit the NDPs 830 and 850 after receiving beamforming report poll frames 820 and 840.

The STA that transmits the NDP 810 to the AP after receiving the NDPA frame 800 may be the STA (the STA that corresponds to the STA indicating information that is firstly indicated by the STA information field.

The AP that receives the NDPs 810, 830 and 850 may estimate the channel between the AP and the STA based on the training field (e.g., very high throughput (VHT)-LTF or high efficiency (HE)-LTF) of the NDPs 810, 830, and 850 and may acquire the channel state information. Since the NDPs 810, 830 and 850 do not have the data field, the length information that indicates the PSDU length included in the data field of the NDPs 810, 830 and 850 and the length of the Aggregate-MAC protocol data unit included in the PSDU may be set to zero.

The AP may perform a channel measurement between the AP and the STA based on the NDPs 810, 830 and 850, and may perform a UL MU transmission based on the acquired channel state information. For example, the AP may allocate the transmission resource for the UL MU transmission based on the channel state information acquired based on NDPs 810, 830 and 850, and may determine the MCS index for the UL data transmitted through a UL frame.

The NDPA frame 800 may also be transmitted based on a DL MU transmission method. Particularly, the NDPA frame 800 may be transmitted to multiple STAs through different space time streams based on a DL MU MIMO transmission, or may be transmitted to multiple STAs through different frequency resources (or subbands, channels) based on the DL MU OFDMA. In such a case, the NDPA frame 800 transmitted through different space time streams or different frequency resources may include the information which is not the same. That is, the AP may transmit multiple NDPA frames to multiple STAs, respectively. For example, the NDPA frame transmitted through a specific space time stream or a specific frequency resource may indicate a specific STA only that is going to transmit a feedback frame.

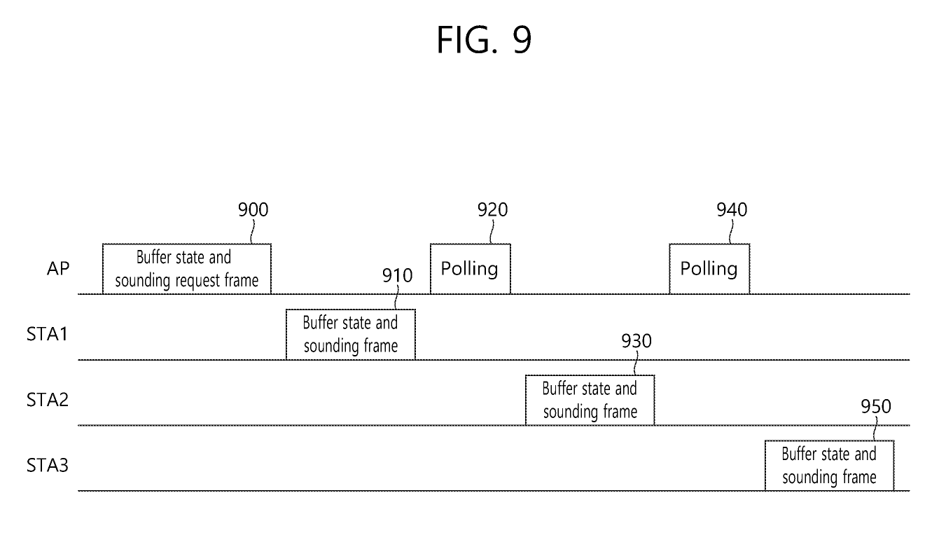

FIG. 9 is a conceptual view illustrating a UL MU transmission preset procedure according to an embodiment of the present invention.

FIG. 9 shows a method for acquiring the channel state information for each of STAs and the buffer state information for each of STAs through a buffer state and sounding request frame 900 that are newly defined for the UL MU transmission preset procedure.

Referring to FIG. 9, an AP may transmit the buffer state and sounding request frame 900 to a plurality of STAs. The buffer state and sounding request frame 900 may be transmitted at least one STA through at least one space time stream based on the non-duplicate PPDU format or the duplicate PPDU format. Otherwise, a plurality of buffer state and sounding request frames 900 may be transmitted to each of the STAs through different frequency resource (or subbands, channels) or different space time streams based on a DL MU transmission.

The buffer state and sounding request frame 900 may include the identification information of the STA (ID of the STA or MAC address of the STA) that is going to measure the buffer state and channel state information. In addition, the buffer state and sounding request frame 900 may include the information for requesting the report for the buffer state information and/or the channel state information, the information for requesting a sounding procedure, and so on.

For example, at least one STA that is indicated by the buffer state and sounding request frame 900 may sequentially transmit the buffer state and sounding frames 910, 930 and 950 to the AP.

The buffer state and sounding frames 910, 930 and 950 may include the training field for acquiring the buffer state information and the channel state information. The buffer state information may include the information on whether the UL data that is pending to the STA is existed or the size of the UL data that is pending to the STA, and so on. The number of the training fields included in the buffer state and sounding frames 910, 930 and 950 may be indicated by the buffer state and sounding request frame. The number of the training fields included in the buffer state and sounding frames 910, 930 and 950 may be determined based on the number of space time streams (or the number of space time streams that indicates the LTF) for transmitting the buffer state and sounding frame.

Otherwise, the buffer state and sounding frames 910, 930 and 950 may include the buffer state information and the channel state information. The channel state information may be the information for transmitting a UL frame, and may be the information generated by the STA. The channel state information may include the information of the number of space time streams, the beamforming matrix, the MCS and the location of subcarrier (or the location of frequency resource (or subband)) that are preferred (or recommended) for the UL MU transmission.

Each of the STAs indicated by the buffer state and sounding request frame 900 may sequentially transmit the buffer state and sounding frames 910, 930 and 950 to the AP. For example, one STA among the multiple STAs indicated by the buffer state and sounding request frame 900 may transmit the buffer state and sounding frame 910 after receiving the buffer state and sounding request frame 900. The remaining STAs among the multiple STAs indicated by the buffer state and sounding request frame 900 may transmit the buffer state and sounding frames 930 and 950 to the AP after receiving polling frames 920 and 940 from the AP.

One STA that transmits the buffer state and sounding frame 910 after receiving the buffer state and sounding request frame 900 may be the STA that is firstly indicated by the buffer state and sounding request frame 900 (the STA that corresponds to the STA indication information that is firstly included in the buffer state and sounding request frame 900).

In the case that the buffer state and sounding frame 910 is transmitted from the STA within a predetermined time (e.g., SIFS) after the transmission of the buffer state and sounding request frame 900, the AP may transmit the polling frame 920.

The PPDU header of the PPDU that delivers at least one of the buffer state and sounding request frame 900, the buffer state and sounding frames 910, 930 and 950 and the polling frames 920 and 940 may not include the legacy part. For example, the PPDU that delivers the buffer state and sounding request frame 900 may include the legacy part in the PPDU header, and the PPDU that delivers the buffer state and sounding frames 910, 930 and 950 and the polling frames 920 and 940 may not include the legacy part. The legacy STAs may configure a NAV based on the legacy part of the buffer state and sounding request frame 900.

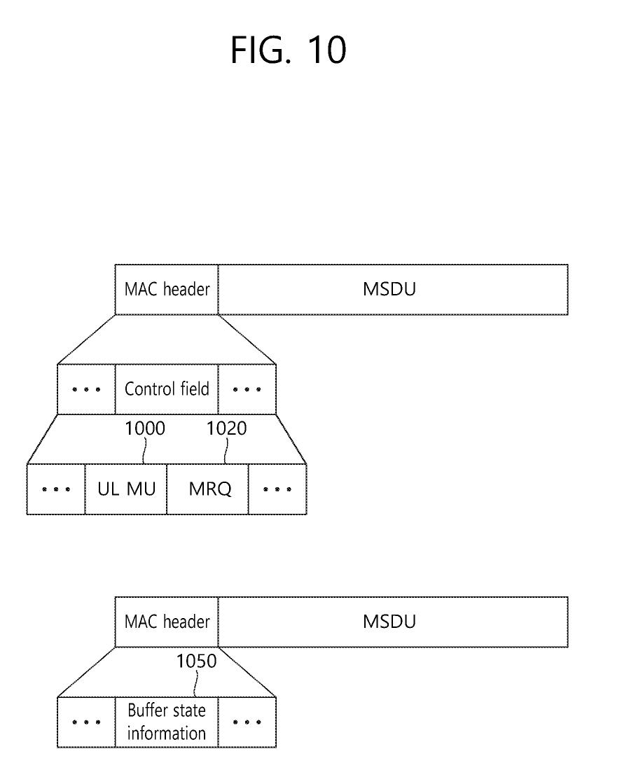

FIG. 10 is a conceptual view illustrating a UL MU transmission preset procedure according to an embodiment of the present invention.

FIG. 10 shows a UL MU transmission preset procedure based on a control field (e.g., VHS control field) of a frame.

The control field included in the MAC header of the frame transmitted by an AP may be used for a request of the buffer state information and/or the channel state information (or a request of the sounding procedure).

The AP may acquire the buffer state information and may perform the sounding procedure by combining the procedure described above in FIG. 8 or FIG. 10. For example, based on the procedure described above in FIG. 8, the AP may acquire the channel state information and may acquire the buffer state information based on the control field included in the MAC header of the transmitted DL frame. Otherwise, based on the procedure described above in FIG. 9, the AP may acquire the channel state information and the buffer state information, may acquire the buffer state information based on the control field included in the MAC header of the transmitted DL frame.

Referring to the upper part of FIG. 10, particularly, the control field (e.g., VHT control field) of the MAC header of a frame transmitted by the AP may be used for the UL MU transmission. For example, a reserved bit among the control field of the MAC header is a field 1000 for the UL MU transmission preset procedure, the AP may request the buffer state information and/or the channel state information (or sounding procedure) by the field.

For example, in the case that the DL frame transmitted by the AP is a frame for the UL MU transmission preset procedure and the MCS feedback request (MRQ) 1020 which is a subfield of the control field is set to 1, the STA may transmit a response frame that includes the buffer state information in response to the frame to the AP.

Referring to the lower part of FIG. 10, in the case that the STA receives the field for requesting the buffer state information/the channel state information (the sounding procedure) from the AP, the STA may transmit the existing frame with the information required for the UL MU transmission (e.g., buffer state information and/or the channel state information) being included, instead of the information which is not required for the UL MU transmission. For example, the STA may include the buffer state information (6 bits) 1050 such as the access category (AC) information (2 bits), the data size information (4 bits), and so on, instead of the GID information (6 bits). Otherwise, in the case that the STA receives the field for requesting the buffer state information/the channel state information (the sounding procedure) from the AP, the STA may transmit the training field for sounding to the AP.

Otherwise, the AP may check the buffer state of the STA periodically based on the frame which is periodically transmitted such as the beacon frame. The AP may transmit the beacon frame with buffer state request information being included to the STA. The buffer state request information may be fixedly or selectively included in the beacon frame. After the beacon frame is transmitted, the AP may receive the buffer state information from the STA based on the polling frame (contention free polling frame). Otherwise, the STA may transmit the UL frame with the buffer state information being included.

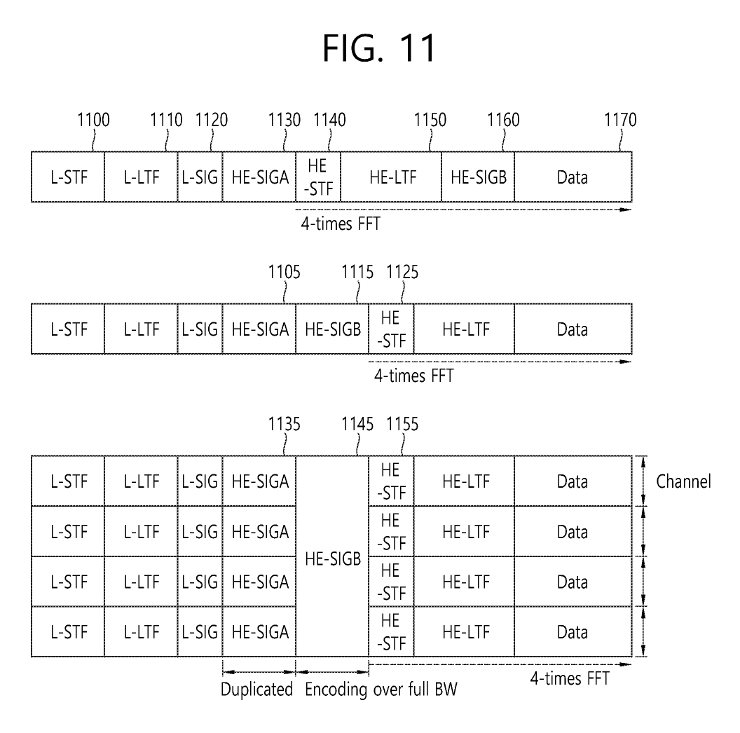

FIG. 11 is a conceptual view illustrating a PPD format for transmitting a frame according to an embodiment of the present invention.

FIG. 11 shows the PPDU format according to an embodiment of the present invention. The PPDU format shown in FIG. 11 may be used for transmitting the RRA frame, the RR frame, the RA frame, the UL frame, the UL transmission scheduling frame, the adjustment frame, the ACK frame, the NDPA frame, the polling frame, the buffer state and sounding request frame and the buffer state and sounding frame.

Referring to the upper part of FIG. 11, the PHY header of the DL PPDU may include a legacy-short training field (L-STF), a legacy-long training field (L-LTF), a legacy-signal (L-SIG), a high efficiency-signal A (HE-SIG A), a high efficiency-short training field (HE-STF), a high efficiency-long training field (HE-LTF) and a high efficiency-signal-B (HE-SIG B).

The L-STF 1100 may include a short training orthogonal frequency division multiplexing (OFDM) symbol. The L-STF 1100 may be used for the frame detection, the Automatic Gain Control (AGC), the diversity detection and the coarse frequency/time synchronization.

The L-LTF 1110 may include a long training orthogonal frequency division multiplexing (OFDM) symbol. The L-LTF 1110 may be used for the fine frequency/time synchronization and channel estimation.

The L-SIG 1120 may be used for transmitting control information. The L-SIG 1120 may include the information of a data rate and a data length.

The HE-SIG A 1130 may also include the information for indicating the STA that is going to receive a PPDU. For example, the HE-SIG A 1130 may include the indicator for a specific STA that is going to receive a PPDU and the information for indicating a group of a specific STA. In addition, in the case that a PPDU is transmitted based on the OFDMA or the MIMO, the HE-SIG A 1130 may also include the resource allocation information for the STA.

In addition, the HE-SIG A 1130 may also include the color bits information for the BSS identification information, the bandwidth information, the tail bit, the CRC bit, the modulation and coding scheme (MCS) information for the HE-SIG B 1160, the symbol number information for the HE-SIG B 1160 and the length information of cyclic prefix (CP) (or gourd interval (GI)).

The HE-STF 1140 may be used for improving the automatic gain control estimation in the multiple input multiple output (MIMO) environment or the OFDMA environment.

The HE-LTF 1150 may be used for estimating a channel in the MIMO environment and the OFDMA environment.

The HE-SIG B 1160 may include the information of a length MCS and the tail bit of a Physical layer service data unit (PSDU) for each STA. In addition, the HE-SIG B 1160 may also include the information for the STA that is going to receive a PPDU and the resource allocation information (or MU-MIMO information) based on the OFDMA. In the case that the resource allocation information (or MU-MIMO information) based on the OFDMA is included in the HE-SIG B 1160, the corresponding information may not be included in the HE-SIG A 1130.

The size of IFFT applied to the HE-STF 1140 and the field after the HE-STF 1140 and the size of IFFT applied to the field before the HE-STF 1140 may be different. For example, the size of IFFT applied to the HE-STF 1140 and the field after the HE-STF 1140 may be four times the size of IFFT applied to the field before the HE-STF 1140. The STA may receive the HE-SIG A 1130 and may be instructed to receive the DL PPDU based on the HE-SIG A 1130. In such a case, the STA may decode based on the changed FFT size from the HE-STF 1140 and the field after the HE-STF 1140. On the contrary, in the case that the STA is instructed to receive a DL PPDU based on the HE-SIG A 1130, the STA may stop decoding and configure a network allocation vector (NAV). The cyclic prefix (CP) of the HE-STF 1140 may have greater size than the CP of other fields, and during the CP duration, the STA may decode the DL PPDU by changing the size of FFT.

The order of fields that construct the format of PPDU shown in the upper part of FIG. 11 may be changed. For example, as shown in the middle part of FIG. 11, the HE-SIG B 1115 of the HE part may be located directly after the HE-SIG A 1105. The STA may decode up to the HE-SIG A 1105 and the HE-SIG B 1115, receive the control information required and perform the NAV configuration. Similarly, the size of IFFT applied to the HE-STF 1125 and the field after the HE-STF 1125 and the size of IFFT applied to the field before the HE-STF 1125 may be different.

The STA may receive the HE-SIG A 1105 and the HE-SIG B 1115. In the case that the reception of a PPDU is instructed based on the HE-SIG A 1105, the STA may decode the PPDU by changing the size of FFT from the HE-SIG B 1115. On the contrary, in the case that the STA receives the HE-SIG A 1105 and the reception of a PPDU is not instructed based on the HE-SIG A 1105, the STA may perform the network allocation vector (NAV) configuration.

Referring to the lower part of FIG. 11, the PPDU format for a downlink (DL) multi-user (MU) transmission is shown. The PPDU may be transmitted to the SAT through different transmission resources (frequency resource or spatial stream). The field before the HE-SIG B 1145 on the PPDU may be transmitted in a duplicated form in each of the different transmission resources. The HE-SIG B 1145 may be transmitted in an encoded form on the entire transmission resources. Otherwise, the HE-SIG B 1145 may be encoded in the same unit (e.g., 20 MHz) as the legacy part and may be transmitted by being duplicated in the unit of 20 MHz on the entire transmission resources. The HE-SIG B 1145 may be encoded in the same unit (e.g., 20 MHz) as the legacy part, but the HE-SIG B 1145 transmitted through each of multiple 20 MHz units on the entire transmission resources may include different types of information.

The field after the HE-SIG B 1145 may include the individual information for each of the STAs that receive the PPDU.

In the case that the fields included in the PPDU are transmitted through the transmission resources, respectively, the CRC for each of the fields may be included in the PPDU. On the contrary, in the case that a specific field included in the PPDU is transmitted by being encoded on the entire transmission resources, the CRC for each field may not be included in the PPDU. Accordingly, the overhead for the CRC may be decreased.

Similarly, for the PPDU format for the DL MU transmission, the HE-STF 1155 and the field after the HE-STF 1155 may be encoded based on the IFFT size which is different from that of the field before the HE-STF 1155. Accordingly, in the case that the STA receives the HE-SIG A 1135 and the HE-SIG B 1145, the STA may decode the PPDU by changing the FFT size after the HE-STF 1155.

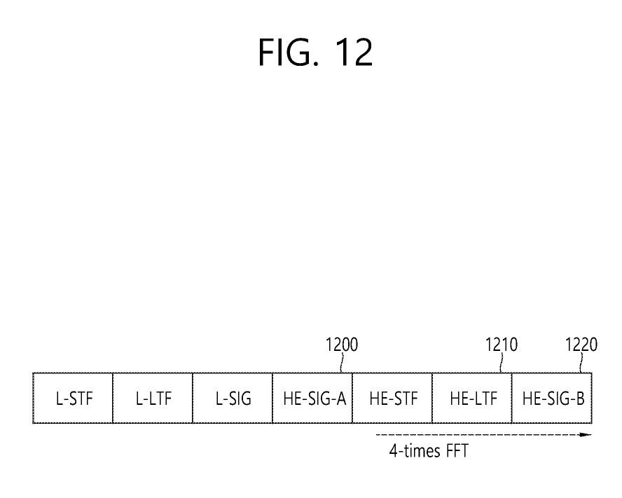

FIG. 12 is a conceptual view illustrating a sync PPDU and an NDP according to an embodiment of the present invention.

FIG. 12 shows the sync PPDU or the NDP format.

Referring to FIG. 12, the NDP or the sync PPDU may include a PPDU header only except a PSDU (or MPDU).

The NDP (or sync PPDU) may include the legacy parts (L-STF, L-LTF and L-SIG) and the non-legacy parts (HE-SIG A, HE-STF, HE-LTF and HE-SIG B). Each of the fields included in the legacy parts and the non-legacy parts may play the role described in FIG. 11 in order to transmit the NDP (or sync PPDU). The NDP may include the non-legacy parts only.

The HE-SIG A 1200 may include the information indicating an STA that is going to receive the NDP or the sync PPDU. In the case that the NDP or the sync PPDU is transmitted by the STA as shown in FIG. 8, the HE-SIG A of the NDP or the sync PPDU may indicate the AP that is going to receive the NDP.

The HE-SIG A 1200 of the sync PPDU may include the information for adjusting time/frequency/power of an AP.

The HE-LTF 1210 may be used for the channel prediction of AP or the adjustment procedure of AP. For example, the STA may perform the channel prediction based on the HE-LTF 1120 included in the NDP frame and may generate the feedback frame based on the result of the channel prediction.

The HE-SIG B 1220 may include the information indicating that the length of PSDU is zero.

In FIG. 12, although the case that the HE-SIG B 1220 is included in the end part of the PPDU header is assumed, the HE-SIG B 1220 may be located directly after the HE-SIG A or may not be included in the PPDU header.

As described in FIG. 12, the order of a part of the fields included in the NDP described above may be changed. That is, each of the fields of the PPDU header may be located in the order of HE-SIG A, HE-SIG B, HE-STF and HE-LTF.

The sync PPDU may also include the PDSU (or MPDU) additionally. The PSDU (MPDU) of the sync PPDU may include the information for adjusting time/frequency/power.

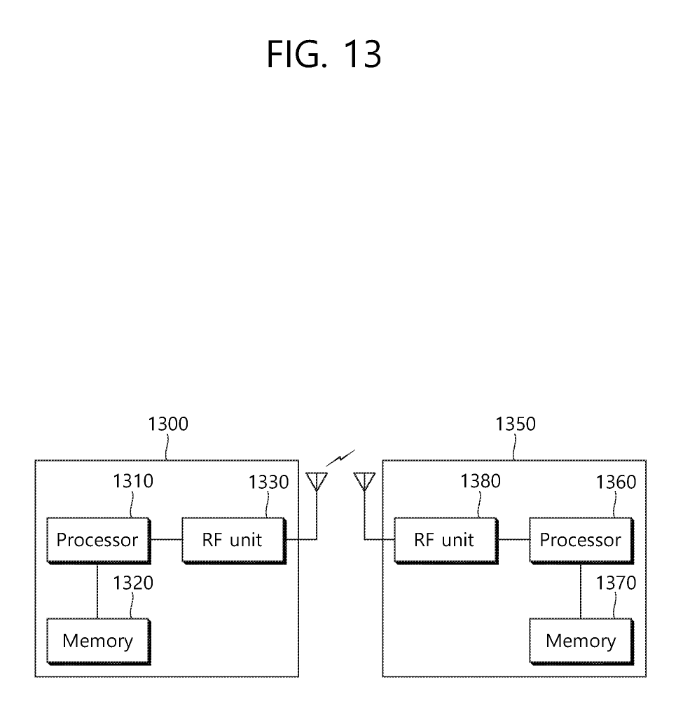

FIG. 13 is a block diagram illustrating the wireless apparatus in which an embodiment of the present invention can be implemented.

Referring to FIG. 13, the wireless apparatus 1300 may be an STA that may implement the embodiments described above, and may also be an AP 1300 or non-AP station (or STA; 1350).

The AP 1300 includes a processor 1310, a memory 1320 and a radio frequency (RF) unit 1330.

The RF unit 1330 may be connected to the processor 1310 and transmits/receives the radio signal.

The processor 1310 implements the proposed functions, processes and/or methods. For example, the processor 1310 may be configured to perform the operation of the AP according to the embodiments of the present invention described above. The processor may perform the operation of the AP described in the embodiments of FIGS. 1 to 14.

For example, the processor 1310 may be implemented so as to transmit an uplink transmission scheduling frame to multiple STAs, to receive a sync PPDU in response to the UL transmission scheduling frame from each of the STAs and to transmit an adjustment frame including adjustment information which is determined based on the sync PPDU to the multiple STAs. In addition, the processor 1310 may be implemented so as to receive a UL frame transmitted based on the adjustment information by each of the STAs on an overlapped time resource and to transmit an ACK frame in response to the UL frame to each of the STAs.

The UL transmission scheduling frame may include UL MU transmission STA information and UL MU transmission resource information, the UL MU transmission STA information may include information indicating the multiple STAs, the UL MU transmission resource information may indicate a transmission resource of the UL frame, and the adjustment information may include information that adjusts a resource for transmitting the UL frame.

The STA 1350 includes a processor 1360, a memory 1370 and a radio frequency (RF) unit 1380.

The RF unit 1380 may be connected to the processor 1360 and transmits/receives the radio signal.

The processor 1360 may implement the proposed functions, processes and/or methods. For example, the processor 1360 may be configured to perform the operation of the STA according to the embodiments of the present invention described above. The processor may perform the operation of the STA described in the embodiments of FIGS. 1 to 14.

For example, the processor 1360 may adjust the time/frequency/power resource for the UL frame transmission based on the adjustment information included in the adjustment frame. In addition, the processor 1360 may be implemented so as to transmit a UL frame based on the adjusted resource.

The processors 1310 and 1360 may include Application-Specific Integrated Circuits (ASICs), other chipsets, logic circuits, data processors and/or converters that reciprocally convert baseband signals and radio signals. The memories 1320 and 1370 may include Read-Only Memory (ROM), Random Access Memory (RAM), flash memory, memory cards, storage media and/or other storage devices. The RF units 1330 and 1380 may include one or more antennas to transmit and/or receive the radio signal.

When the embodiment is implemented in software, the aforementioned scheme may be implemented as a module (process or function) that performs the aforementioned function. The module may be stored in the memories 1320 and 1370, and may be executed by the processors 1310 and 1360. The memories 1320 and 1370 may be placed inside or outside the processors 1310 and 1360 and may be connected to the processors 1310 and 1360 using a variety of well-known means.

What is claimed is:

1. A method for receiving a frame in a wireless LAN, comprising:
transmitting, by an access point (AP), an uplink transmission scheduling frame to multiple stations (STAs);
receiving, by the AP, a sync physical layer protocol data unit (PPDU) in response to the uplink transmission scheduling frame from each of the STAs;
transmitting, by the AP, an adjustment frame including adjustment information which is determined based on the sync PPDU to the multiple STAs;
receiving, by the AP, an uplink frame transmitted based on the adjustment information by each of the STAs on an overlapped time resource; and
transmitting, by the AP, an acknowledgement (ACK) frame in response to the uplink frame to each of the STAs,
wherein the uplink transmission scheduling frame includes uplink (UL) multi-user (MU) transmission STA information and UL MU transmission resource information,
wherein the UL MU transmission STA information includes information indicating the multiple STAs,
wherein the UL MU transmission resource information indicates a transmission resource of the uplink frame, and
wherein the adjustment information includes information that adjusts a resource for transmitting the uplink frame.

2. The method of claim 1, wherein the adjustment information includes at least one of time adjustment information, frequency adjustment information and power adjustment information,
wherein the time adjustment information includes information for adjusting a transmission timing of the uplink frame,
wherein the frequency adjustment information includes information for adjusting a transmission frequency band of the uplink frame, and
wherein the power adjustment information includes information for adjusting a transmission power of the uplink frame.

3. The method of claim 1, wherein the sync PPDU includes a PPDU header only.

4. The method of claim 1, wherein the ACK frame includes an ACK signal for the uplink frame, when decoding for the uplink frame is successful, and
wherein the ACK frame includes information for retransmitting a NACK signal and the uplink frame for the uplink frame, when decoding is failed.

5. The method of claim 1, wherein the sync PPDU is transmitted by being multiplexed based on code division multiplexing (CDM), time division multiplexing (TDM) or space division multiplexing (SDM) based on the transmission resource allocated according to an indication order of the multiple STAs on the UL MU transmission STA information.

6. An access point (AP) for receiving a frame in a wireless LAN, comprising:
a radio frequency (RF) unit configured to transmit or receive a radio signal; and
a processor operatively connected to the RF unit,
wherein the processor is configured to perform:
transmitting an uplink transmission scheduling frame to multiple stations (STAs);
receiving a sync physical layer protocol data unit (PPDU) in response to the uplink transmission scheduling frame from each of the STAs;
transmitting an adjustment frame including adjustment information which is determined based on the sync PPDU to the multiple STAs;
receiving an uplink frame transmitted based on the adjustment information by each of the STAs on an overlapped time resource; and
transmitting an acknowledgement (ACK) frame in response to the uplink frame to each of the STAs,
wherein the uplink transmission scheduling frame includes uplink (UL) multi-user (MU) transmission STA information and UL MU transmission resource information,
wherein the UL MU transmission STA information includes information indicating the multiple STAs,
wherein the UL MU transmission resource information indicates a transmission resource of the uplink frame, and
wherein the adjustment information includes information that adjusts a resource for transmitting the uplink frame.

7. The AP of claim 6, wherein the adjustment information includes at least one of time adjustment information, frequency adjustment information and power adjustment information,
wherein the time adjustment information includes information for adjusting a transmission timing of the uplink frame,
wherein the frequency adjustment information includes information for adjusting a transmission frequency band of the uplink frame, and
wherein the power adjustment information includes information for adjusting a transmission power of the uplink frame.

8. The AP of claim 6, wherein the sync PPDU includes a PPDU header only.

9. The AP of claim 6, wherein the ACK frame includes an ACK signal for the uplink frame, when decoding for the uplink frame is successful, and
wherein the ACK frame includes information for retransmitting a NACK signal and the uplink frame for the uplink frame, when decoding is failed.

10. The AP of claim 6, wherein the sync PPDU is transmitted by being multiplexed based on code division multiplexing (CDM), time division multiplexing (TDM) or space division multiplexing (SDM) based on the transmission resource allocated according to an indication order of the multiple STAs on the UL MU transmission STA information.
